(19) United States
(12) Patent Application Publication
(10) Pub. No.: US 2025/0006074 A1
(43) Pub. Date: Jan. 2, 2025

(54) Enabling Interactive Learning Activities

(71) Applicant: Bamboo Learning, Inc., Seattle, WA (US)

(72) Inventors: Irina Fine, Scarsdale, NY (US); Michael Nail, Portland, OR (US); Zachary Rubin, Seattle, WA (US); Jessica Poore, Lynnwood, WA (US); Ian Freed, Seattle, WA (US)

(73) Assignee: Bamboo Learning, Inc., Seattle, WA (US)

(21) Appl. No.: 18/215,294

(22) Filed: Jun. 28, 2023

(51) Int. Cl. G09B 7/02; G09B 5/06

(52) U.S. Cl. CPC G09B 7/02; G09B 5/06

(57) ABSTRACT

A method for interacting with an audience for education purposes including receiving a prompt to begin an education process, wherein the prompt is received by one or more microphones, audibly providing content to an audience via one or more speakers based at least in part on the prompt, visually providing the content to an audience via one or more screens, prompting the audience with one or more questions via the one or more speakers once the content has finished, prompting the audience with one or more questions via the screens once the content has finished, providing the audience with a choice of response method, and receiving a response via the chosen response method.

### BACKGROUND

Most learning applications provide only one type of interface—typically a screen-based approach. The screen-based approach may include touch-based on a tablet or mouse-based on a computer. This singular approach requires a user to read to participate in the learning activity. Furthermore, this approach does not assess a student's ability to competently respond vocally to the prompt. Additionally, this singular approach fails to assess the combination of listening, reading, and speaking collectively. This approach may also create screen fatigue.

### BRIEF SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The ability to provide flexible interactive learning solutions that enable learners to answer either via multiple methods expands learning to a broader range of users and offers increased convenience and higher level of engagement for all users. For example, children who can't yet read, but can understand content and interactive learning activities when supplemented with audio and images, can answer questions verbally even if they can't yet read the questions and answer choices on a tablet or computer screen. Additionally, interactive learning that requires reading and written answers is often inaccessible to users of any age with dyslexia and other learning differences. However, if users have the power to choose whether to answer each question using their voice, touch-based, or mouse-based input, they have the opportunity to quickly and easily progress in the learning activities. The student is no longer constrained by the single input response abilities. By offering a choice of interface on every question for interacting with learning activities, the student experiences a more engaging and effective learning experience that allows the specific type of interface to melt into the background and focuses attention on the learning activities themselves.

### BRIEF DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 illustrates an example environment that supports voice recognition learning environments in accordance with aspects of the present disclosure;

FIG. 2 is a block diagram of an example interactive education module in accordance with aspects of the present disclosure;

FIG. 3 is a flow diagram in accordance with exemplary embodiments described herein

FIG. 4 illustrates a block diagram of a computer system in accordance with aspects of the present disclosure.

### DETAILED DESCRIPTION

The detailed description set forth below in connection with the appended drawings, where like numerals reference like elements, are intended as a description of various embodiments of the present disclosure and are not intended to represent the only embodiments. Each embodiment described in this disclosure is provided merely as an example or illustration and should not be construed as precluding other embodiments. The illustrative examples provided herein are not intended to be exhaustive or to limit the disclosure to the precise forms disclosed.

In the following description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

In some embodiments described herein, a user is given the ability to answer questions using either their voice or touch. The learner will find the easiest method of answering each question. The approach to answering each question might change based on a number of factors—the learner's mood, level of fatigue, what else they did that day, the type of question being asked, the type of content, etc. To provide this flexibility, the embodiments described here eliminate any requirement to answer each question using a particular input method. The embodiments may provide the ability to answer open-ended questions via touch if the user asks for a hint, or needs a bit of help, by converting open-ended questions into multiple-choice questions with multiple-choice answers.

By providing a more flexible learning environment, the user is no longer required to answer questions using one particular input method when more than one can be made available for each question. This in turn may make learning easier, increasing effectiveness and enjoyability for the users.

The embodiments disclosed provide flexibility to how a user will participate in a learning activity. That flexibility is available to the user on each question. It would be possible to provide a teacher, tutor, or parent the ability to require answers of certain types of questions using either voice or touch. This might help a learner address an area that may need improvement.

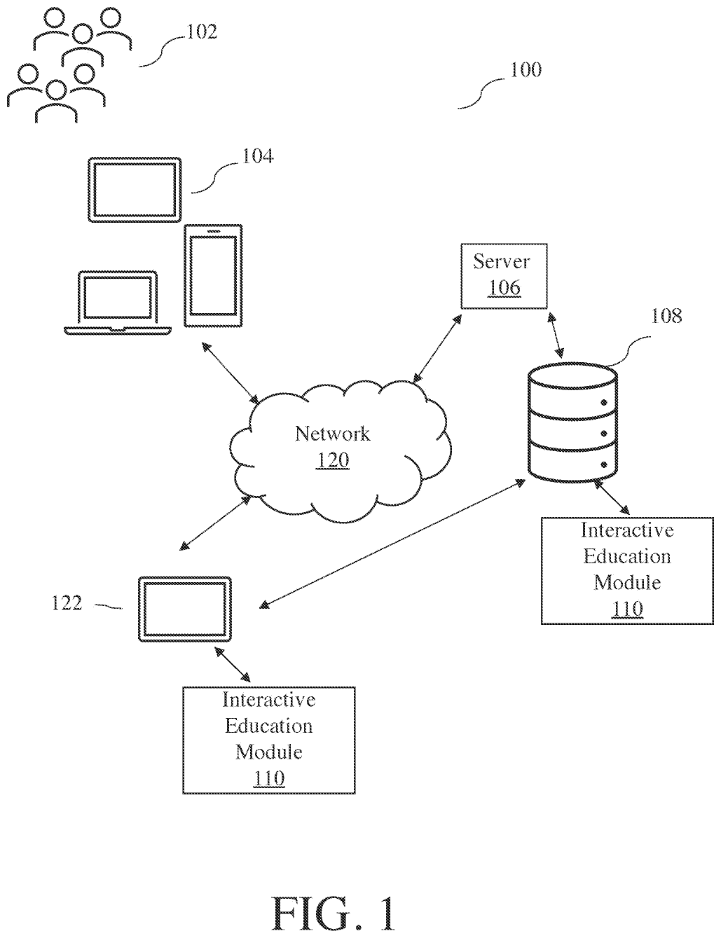

FIG. 1 is a block diagram illustrating one embodiment of an environment 100 in which the present systems and methods may be implemented. The environment 100 may include one or more users or consumers 102, one or more devices 104 associated with the users 102, one or more databases or servers 106, 108, and a network 120 that allows the different parts of the system 100 to communication with one another.

Examples of the device 104 may include a mobile phone, a laptop, a desktop computer, a fablet, a tablet, a smart watch, mobile computing device, smart phone, smart assistants, conversational agent device, smart speakers, personal computing device, computer, server, etc.

In some embodiments, devices 104 may communicate with one or more servers 106 via network 120. Examples of a network 120 include cloud networks, local area networks (LAN), wide area networks (WAN), virtual private networks (VPN), wireless networks (using 802.11, for example), cellular networks (using 3G and/or LTE, for example), etc. In some configurations, the network 120 may include the internet. In some embodiments, devices 104 include a mobile application that interfaces with one or more functions of interactive education module 110.

Examples of the server 106 may include a server administered by an educational learning company or another company that uses voice prompts and voice recognition to aid in education with users and consumers. In some embodiments, the system 100 may include additional servers which may be coupled to or implement the interactive education module 110.

In some embodiments, server 106 may be coupled to databases 108. Database 108 may include an interactive education module 110. In other embodiments, the interactive education module 110 may be located on a device 122. The device 122 may include any one of the examples of devices 104. In still further embodiments, the device 122 may access the interactive education module 110 via the server 106. Database 108 may be internal or external to the server 106. In one example, device 122 may be coupled directly to database 108, database 108 being internal or external to device 122.

In still further embodiments, the device 104 may access the interactive education module 110 via the server 106. Database 108 may be internal or external to the server 106. In one example, a device 104 may be coupled directly to database 108, database 108 being internal or external to device 104. The interactive education module 110 may comprise the software and data necessary to implement an educational program with a voice prompts and voice recognition responses.

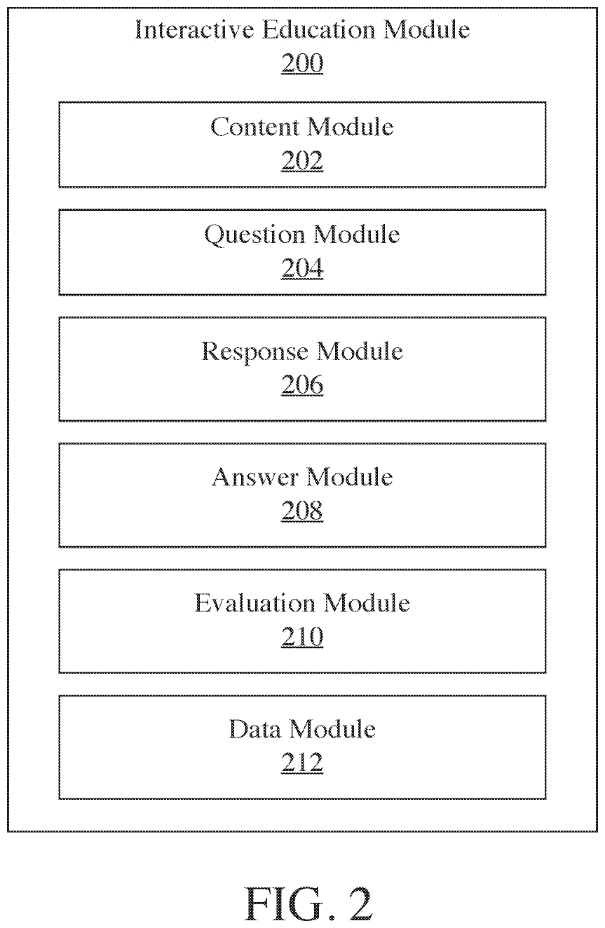

FIG. 2 is a block diagram illustrating components of one example of an interactive education module 200. The interactive education module 200 may be one example of the interactive education module 110 described with reference to FIG. 1. In this example, the interactive education module 200 has content module 202, a question module 204, a response module 206, an answer module 208, an evaluation module 210, and a data module 212.

The content module 202 may include both the content and metadata of the content. The content module 202 may also include several pieces of written, narrated, or spoken content such as a book, story, fairy tale, fable, essay, lesson, or other work of fiction or nonfiction.

In some embodiments, the content module 202 may categorize the content or learning activities into groups. This may reduce the number of models needed for the entire learning application. Reducing the number of models could reduce the size of the model, perhaps simplifying model creation or improving speed. Likewise, the content module 202 would communicate the groups to the question and response modules 204, 206 which would poll from the same sub-group for questions and answers.

In still further embodiments, the content module 202 may sub-divide content based on the device (e.g. device 102, FIG. 1) used. For example, the content module 202 may have one context-specific model to send to Alexa®, and another context-specific model to send to Google®. This approach may increase overall accuracy even more.

The question module 204 may include a series of context-specific questions for each content element in the content module 202. These context-specific questions should be answerable via voice by stating a letter, number, word, phrase, or sentence. The answers (whether words, phrases, or sentences) may include synonyms of words used in the content. These context specific questions should also be answerable via touch interface by tapping on a screen-based button control or using drag and drop controls. For example, a touch interface answer may be used for questions featuring True/False and multiple-choice answers. Similarly, drag and drop controls may be used for questions featuring unscramble the sentence and fill in the blank answers.

The response module 206 may include a series of likely correct and incorrect answers, including sentences, words, phrases, letters, and numbers, true/false, or multiple choice. In some embodiments, the likely correct and incorrect answers need not be an exhaustive, perfectly phrased list of every possible answer. Whereas, for some other answers, such as True/False or multiple-choice questions, there are clear answers.

In some embodiments, the answer module 208 may include a single voice recognition model with a tuned vocabulary. The tuned vocabulary may be trained to expect at different states in the application. In some embodiments, the answer module may include a system for converting the content metadata and the context-specific questions into questions and answer, both correct and incorrect, that can be displayed on the screen using touch-screen controls such as buttons, drag and drop elements, and multi-selection elements. This may provide the student the ability to answer questions either using their voice or using a keypad, mouse, or touchscreen. The ability to use multiple input methods and also visually see the answers available may aid students through their educational journey. For example, a student struggling with content intake may benefit from seeing various different answers on the screen to improve their recall. Likewise, a student struggling to read may benefit from seeing potential answers written out. Other data input methods may include including keyboards and neural interfaces, as alternatives to touch and voice.

The answer module 208 may convert the content metadata, the context-specific questions, and the likely correct and incorrect answers into one or more voice recognition models for each element of content. This system can be manual, semi-automated, or automated. In some embodiments, the answer module 208 may also dynamically load the correct voice recognition model(s) at runtime based on the state of the application.

In some embodiments, the answer module 208 may include one or more voice recognition models for each piece of content. Since accuracy is dependent on the voice recognition model being used at the time, the more specific a model can be, the better the accuracy of the voice recognition model.

In some embodiments, the answer module 208 may understand and interpret multiple languages, whether using voice or touch. For bilingual learners, this added flexibility could be quite powerful. It may provide them the ability to increase their knowledge of one language while also having the ability to use their native language.

In some embodiments, the answer module 208 could provide the ability to require learners to answer specific question or types of questions (i.e., fill-in-the-blank for adjectives) via a particular method (e.g., voice-only). This may enable the educator to dictate certain types of learning methods the student may need to improve upon. It may also enable the educator to test the patient on their performance to determine where the student might require improvement.

The evaluation module 210 may determine an answer to the question. For example, if it is an audible response, the evaluation module 210 may recognize and translate the response into data and compare the response to acceptable answers. The evaluation module 210 may also determine if a haptic response was input and response to the learner in turn.

The data module 212 may store multiple data points relating to the disclosure. In some embodiments, the data module 212 may also offer a machine-learning based approach to the type of input, and permit learners to either work on areas that need improvement (e.g., trouble answering fill-in-the-blank questions using voice) or reinforce learner's strengths (e.g., great at answering fill-in-the-blank questions using touch).

In some embodiments, the data module 212 includes a list of all the data for the education learning module 200. The data module 212 may evaluate the responses for accuracy, store content information, and track the student's progress.

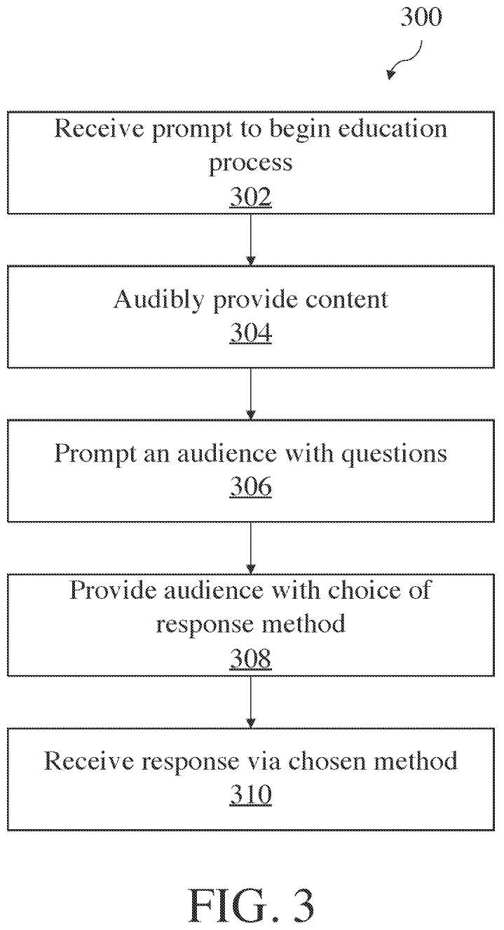

FIG. 3 is a flow chart illustrating an example of a method 300 for determining user response to prompts and evaluation of user response to prompts in a conversational education learning system, in accordance with various aspects of the present disclosure. For clarity, the method 300 is described below with reference to aspects of one or more of the systems described herein.

At block 302, the method 300 may receive a prompt to begin an education process, wherein the prompt is received by one or microphones.

At block 304, the method 300 may audibly provide the content to an audience via one or more speakers.

At block 306, the method 300 may prompt the audience with one or more questions via the speakers once the content has finished.

At block 308, the method 300 may provide the audience with a choice of response method.

At block 310, the method 300 may receive a response via the chosen response method.

Thus, the method 300 may provide for one method of determining user response to prompts and evaluation of user response to prompts in a conversational education learning system. It should be noted that the method 300 is just one implementation and that the operations of the method 300 may be rearranged or otherwise modified such that other implementations are possible.

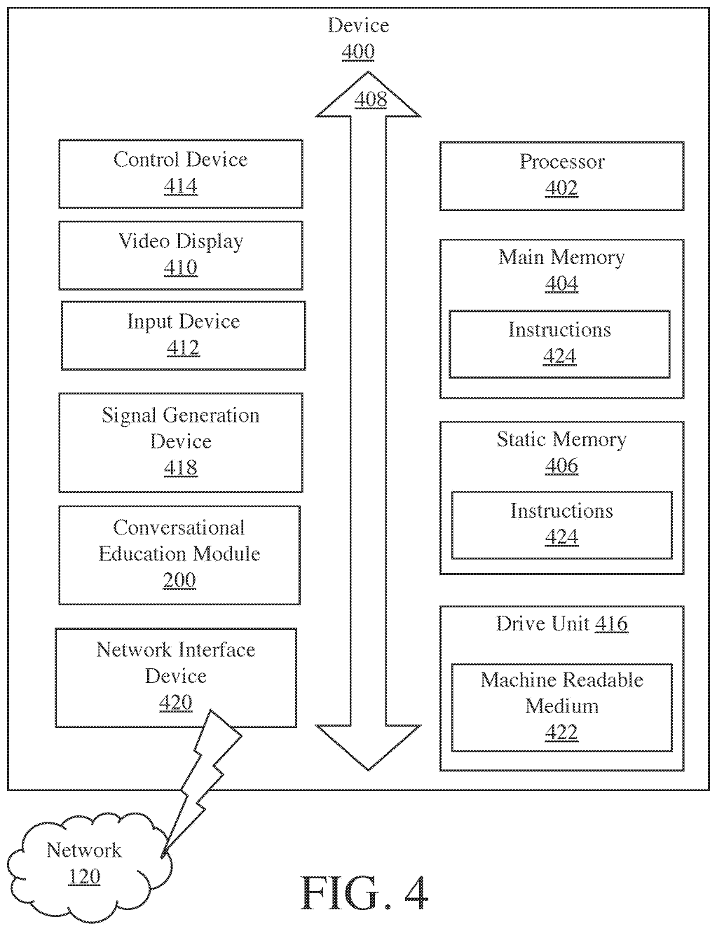

FIG. 4 is a diagram displaying various components of an example device 400. The device 400 may include a set of instructions causing the device 400 to perform any one of more of the methodologies described herein. In some embodiments, the device 400 may be an example of devices 104, 122 as shown in FIG. 1. In alternative embodiments, the device 400 may operate as a standalone device or may be connected (e.g., networked) to other machines. In a networked deployment, the device 400 may operate in the capacity of a server or a client machine in server-client network environment, or as a peer machine in a peer-to-peer (or distributed) network environment. The device 400 may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single device 400 is illustrated, the term “machine” shall also be taken to include any collection of machines that individually or jointly execute a set (or multiple sets) of instructions to perform any one or more of the methodologies discussed herein. The device 400 may include any combination of elements described herein.

The device 400 includes a processor 402 (e.g., a central processing unit (CPU) a graphics processing unit (GPU) or both), a main memory 404 and a static memory 406, which communicate with each other via a bus 408. The device 400 may further include a video display unit 410 (e.g., a liquid crystal display (LCD) or a cathode ray tube (CRT)). The device 400 also includes an alphanumeric input device 412 (e.g., a keyboard), a cursor control device 414 (e.g., a mouse), a disk drive unit 416, a signal generation device 418 (e.g., a speaker) and a network interface device 420.

The disk drive unit 416 includes a machine-readable medium 422 on which is stored one or more sets of instructions (e.g., software 424) embodying any one or more of the methodologies or functions described herein. The software 424 may also reside, completely or at least partially, within the main memory 404 and/or within the processor 402 during execution thereof by the device 400, the main memory 404 and the processor 402 also constituting machine-readable media.

The software 424 may further be transmitted or received over a network 120 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Reference numerals: In this description a single reference numeral may be used consistently to denote a single item, aspect, component, or process. Moreover, a further effort may have been made in the preparation of this description to use similar though not identical reference numerals to denote other versions or embodiments of an item, aspect, component or process that are identical or at least similar or related. Where made, such a further effort was not required, but was nevertheless made gratuitously so as to accelerate comprehension by the reader. Even where made in this document, such a further effort might not have been made completely consistently for all of the versions or embodiments that are made possible by this description. Accordingly, the description controls in defining an item, aspect, component or process, rather than its reference numeral. Any similarity in reference numerals may be used to infer a similarity in the text, but not to confuse aspects where the text or other context indicates otherwise.

The claims of this document define certain combinations and subcombinations of elements, features and acts or operations, which are regarded as novel and non-obvious. The claims also include elements, features and acts or operations that are equivalent to what is explicitly mentioned. Additional claims for other such combinations and subcombinations may be presented in this or a related document. These claims are intended to encompass within their scope all changes and modifications that are within the true spirit and scope of the subject matter described herein. The terms used herein, including in the claims, are generally intended as “open” terms. For example, the term “including” should be interpreted as “including but not limited to,” the term “having” should be interpreted as “having at least,” etc. If a specific number is ascribed to a claim recitation, this number is a minimum but not a maximum unless stated otherwise. For example, where a claim recites “a” component or “an” item, it means that the claim can have one or more of this component or this item.

In construing the claims of this document, the inventor(s) invoke 35 U.S.C. § 112 (f) only when the words “means for” or “steps for” are expressly used in the claims. Accordingly, if these words are not used in a claim, then that claim is not intended to be construed by the inventor(s) in accordance with 35 U.S.C. § 112 (f).

What is claimed is:

1. A method for interacting with an audience for education purposes, the method including:
receiving a prompt to begin an education process, wherein the prompt is received by one or more microphones;
audibly providing content to an audience via one or more speakers based at least in part on the prompt;
visually providing the content to an audience via one or more screens;
prompting the audience with one or more questions via the one or more speakers once the content bas finished;
prompting the audience with one or more questions via the screens once the content has finished;
providing the audience with a choice of response method; and
receiving a response via the chosen response method.

2. The method of claim 1 wherein the choice of response method includes at least one of an audio input or touch input or combination thereof.

3. The method of claim 1, further comprising:
providing one or more questions via speakers and/or screens based on content and content metadata stored in a database, server, or other content repository.

4. The method of claim 1, further comprising:
determining which input method takes precedence over the other input methods to be evaluated by the software application based on timing, likely intent, and additional factors.

5. The method of claim 1, further comprising:
determining if more than one input method can be used to simultaneously evaluate audience responses to one or more questions.

6. The method of claim 1, further comprising:
evaluating results of audience responses using one or more input methods.

7. The method of claim 1, further comprising:
rendering questions in audio format using one or more speakers based on content and metadata of content stored in a database, server, or other content repository.

8. The method of claim 1, further comprising:
rendering questions in visual format using one or more screens based on content and metadata of content stored in a database, server, or other content repository.

9. The method of claim 1, further comprising:
synchronizing rendering of audio and visual elements of questions based on content and metadata of content stored in a database, server, or other content repository.
